(19) United States
(12) Patent Application Publication
(10) Pub. No.: US 2004/0096622 A1
(43) Pub. Date: May 20, 2004

(54) Multi well plate with self sealing advantages

(76) Inventors: Ali Razavi, Vineland, NJ (US); Donald Bayer, Vineland, NJ (US)

Correspondence Address: BIRCH STEWART KOLASCH & BIRCH, PO BOX 747, FALLS CHURCH, VA, 22040-0747, US

(21) Appl. No.: 10/460,198

(22) Filed: Jun. 13, 2003

Related U.S. Application Data
(60) Provisional application No. 60/389,713, filed on Jun. 19, 2002.

(51) Int. Cl. B32B 5/00

(52) U.S. Cl. 428/98

(57) ABSTRACT

The present invention is drawn to a method of making a sealing product by a) selecting a multi-well plate, which satisfies the all intended laboratory and pharmaceutical applications; b) treating the multi-well sealing surface; and c) coating the sealing surface of multi-well plate with an adhesive in a pattern format. The present invention is further drawn to a self-sealing product made by the aforementioned method.

### FIELD OF THE INVENTION

The present invention is drawn to an improved sealing product in the form of a multi-well plate having a self-sealing surface.

### BACKGROUND OF THE INVENTION

Multi-well plates and tube arrays are used extensively in a variety of laboratory and pharmaceutical applications, including, but not limited to, experimental assays, sorbent assays, high-throughput screening (HTS) assays, combinatorial chemistry, drug discovery, drug metabolism studies, liquid chromatography with tandem mass spectrometry (LC-MS-MS), cell culture, tissue culture, and PCR analysis.

Multi-well plates and tube arrays are commercially available from many sources and are typically sold in 4-, 6-, 12-, 24-, 48-, 96-, 384-, and 1536-well designs. Multi-well plates and tube arrays are generally made of polyolefins, including but not limited to polystyrene, polypropylene and others in virgin state or mixed with other materials in order to provide clear, white and/or black micro-plates, and have full-, semi- and non-skirted side profiles among the others. The foot print dimensions of these plates are typically maintained as constant measurements, with the only variation in design being in the number of the wells per plate and the associated well volume. There are a variety of sealing films with adhesive backing that are commercially available for sealing the surface of multi-well/multi-tube arrays for different applications. These sealing films can be heat-sealed or adhered to the surface of the plate by pressure application. Sealing films for sealing multi-well plates with adhesive backing are typically made from aluminum foil, polyester, polypropylene, etc, and are available in single-layer, multi-layer or roll form. However, the current film materials and methods for sealing multi-well plates with adhesive backed films have many significant drawbacks, including adhesive contact with the content of the wells, contamination of needles with adhesive when penetrating through sealing films to access the contents of the wells, limited chemical resistance to many solvent-based solutions in the wells, such as DMSO-containing solutions, leaching of plasticizer that is present in the sealing films by the well contents, and condensation into the well area during thermo-bonding of the sealing film to plate.

Alternatively, the wells may be sealed by placing flexible rubber mats with raised dimples on the surface of the mat in an array, wherein the dimple array matches exactly the array of the wells. Each dimple is sized and shaped to fit firmly into the wells. However, this sealing method using dimples has limited usage due to the constraint of well size and geometry related to the plate design. Specifically design and manufacture of a mat with dimples matching the plate becomes extremely difficult when the mat requires more than 96 wells per plate.

The present invention provides multi-well plates having adhesive incorporated in a pattern format on the desired sealing surface of the plate rather than on the sealing films or mats and others. Multi-plates with self-sealing adhesive provides adhesive free areas, which are not in contact with the well content of the plate.

### SUMMARY OF THE INVENTION

The present invention provides multi-well plate and/or multi-tube array surfaces having adhesive incorporated in a pattern format on the desired sealing surface of the plate instead of on the sealing films or mats etc., used to cover the plate. The present invention provides adhesive free areas, which are not in contact with the well contents of the multi-well plate, having a 4-, 6-, 12-, 24-, 96-, 384-, or 1536-well etc. geometry and design.

This invention further provides a sealing solution that is incorporated on the surface of multi-well plate products with an adhesive free design, and which is suitable for applications regardless of temperature and other restraints.

### BRIEF DESCRIPTION OF THE DRAWINGS

FIG. 1 is a schematic of a front view area of a typical 96-well plate.

FIG. 2 is a schematic of a front view area of a typical 96-well plate having the self-sealing pattern adhesive of the invention.

### DETAILED DESCRIPTION OF INVENTION

Multi-well plates are commercially available with 4-, 6-, 12-, 24-, 48-, 96-, 384-, and 1536-well designs which are generally made of polyolefins, including but not limited to polystyrene, polypropylene and others in virgin state or mixed with other materials in order to provide clear, white and black micro-plates, with full-, semi- and non-skirted side profiles among the others. The foot-print dimensions of these plates typically remains constant, with the only variation design being the number of wells per plate and the associated desired well volume intended for different applications. The wells are typically connected together and attached to the outer periphery of the plate by variety of desired geometries intended for different applications. As result of these options, a variety of topographical well profiles with outer borders of the plate shape, including but not limited to raised rims around each individual wells, flat well rims, well to well connections through negative space which is known commercially as chimney profile, non-chimney profile, wells with different wall thickness and others are possible. A 96 multi-well plate is one popular standard, which comes with an 8×12 array of wells. The cross-sectional area of the wells may be circular, rectangular, or any specific geometry desired.

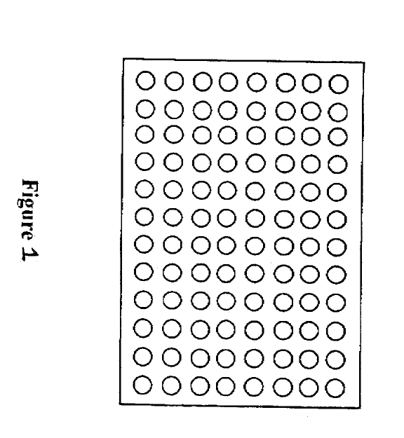

FIG. 1 is a schematic of a front view area of a typical 96 well plate, having circular 8×12 wells with flat rims around each well and without a chimney profile located in a specific array. Each circle is indicative of the diameter of each well arranged in a specific area. The purpose of this invention is to incorporate desired adhesive to the surface of multi-well plate in the desired pattern format, which provides adhesive-free well areas. Furthermore, the sealing solution provides optional design in connecting the adhesive to the periphery and outer boarders of the plate with any preferred pattern in order to optimize the intended self-sealing properties of the multi-well plate surfaces when applied for different applications.

Thus, for the present invention, a multi-well plate surface, such as that exemplified in FIG. 1 or any other design, is covered with preferred adhesive in the desired pattern format by first selecting the appropriate multi-well plate for all intended laboratory and pharmaceutical applications including but not limited to experimental assays, sorbent assays, high-throughput screening. (HTS), combinatorial chemistry, drug discovery, drug metabolism, liquid chromatography with tandem mass spectrometry (LC-MS-MS), cell culture, tissue culture, PCR and other DNA analysis.

The selected multi-well plate surface is then treated to any desired depth and degree of functionality using chemical treatment; plasma treatment, such as by the techniques disclosed in U.S. Pat. No. 6,057,414; corona; flame treatment; mechanical treatment or by adding or mixing wetting agents as a mixture with or coating on the desired multi-well plate materials so that the plate materials will accept the adhesive, which may be, but is not limited to, water-based, solvent-based, heat-activated, and/or UV curable adhesives, which may be colored or in a transparent virgin color.

The surface of multi-well materials are coated with the desired adhesive in pattern format including but not limited to 4-, 6-, 12-, 24-, 48-, 96-384- or 1536-well plate format, with raised rims around each individual wells, flat well rims, well to well connections through chimney profiles, or non-chimney profiles. Furthermore the periphery of the wells including the outer periphery of the surface of the multi-well product may be coated either with connected, continuous adhesive or with any desired pattern adhesive format design. As such, many options are available in designing the periphery of adhesive-free well areas and the outer periphery of the multi-well products with pattern adhesives, which match with multi-well plate's topographical design in order to achieve optimum self-sealing. The above option provides unlimited pattern adhesive designs for the periphery of adhesive free wells and the outer periphery of multi-well products including but not limited to: connected donut shape, disconnected donut shape, rectangular perimeter, triangular perimeter and connection to outer border and other geometries and combinations.

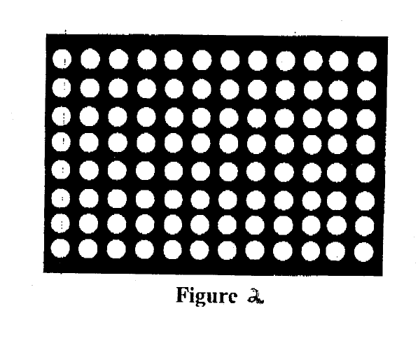

FIG. 2 is a schematic of a front view area of a typical 96 well plate having the self-sealing pattern adhesive of the invention. In the embodiment depicted in FIG. 2, adhesive-free circles represent the surface profile of the micro-plate's wells. The rest of the areas including the periphery of the wells (black areas) provide continuous adhesive sealing surfaces on multi-well plate surface.

By placement of the adhesive the surface of multi-well surface instead of on sealing films, a variety of adhesive free films and mat materials and their laminates become available to seal the multi-well plate surface. These adhesive-free materials that can be selected from fluorinated or non-fluorinated materials including, but not limited to perfluoroalkoxy tetafluoroethylene copolymer resin (PFA), ethylenechlorotrifluoroethylene copolymer resin (E-CTFE), ethyleneterafluoroethylene copolymer resin (E-TFE), poly chlorotrifluoroethylene (CTFE), polyvinylidine fluoride (PVDF), tetrafluoroethylene-hexafluoropropylene (FEP), polytetafluoroethylene (PTFE), expanded PTFE, porous PTFE, woven glass impregnated with PTFE, skived, skived plus calendared PTFE, ACLAR homopolmer, ACLAR copolymer, Dyneon TFM, polyamides (KAPTON), polyolefin's (such as low and high density polyethylene and polypropylene), acrylic polymers and copolymers (such as polyacrylate, polymethylmethacrylate and polyethylacrylate), vinyl halide polymers and copolymers (such as polyvinylidene fluoride, polyvinylidene chloride, polyacrylonitrile, polyvinyl acetate), ethylene-methyl methacrylate copolymers, acrylonitrilestyrene copolymers, ABS resins, ethylene-vinyl acetate copolymers, natural and synthetic rubbers, butadienestyrene copolymers, polyisoprene, synthetic polyisprene, polybutadiene, butadiene-acrylonitrile copolymers, polychloroprene rubbers, polyisbutylene rubber ethylene-propylene rubber, ethylene-propylene-diene rubbers, isobutylene-isoprene copolymers, polyurethane rubbers, polyamides (such as NYLON 66 and polycaprolactam), polyesters (such as polyethylene terephthalate, polycarbonates, polyimides and polyethers), polyolefins, fluorpolmer laminates, Barex and Barex laminates, porous PTFE, woven glass impregnated with PTFE, skived or skived plus calendared PTFE, ACLAR homopolmer, ACLAR copolmer, dyneon TFM, polyimides (KAPTON), polyolefins, acrylic polymers and copolymers, vinyl halide polymers and copolymers, ethylene-methyl methacrylate copolymers, acrylonitrilestyrene copolymers, ABS resins, ethylene-vinyl acetate copolymers, natural and synthetic rubbers, butadienestyrene copolymers, polyisoprene, synthetic polyisprene, polybutadiene, butadiene-acrylonitrile copolymers, polychloroprene rubbers, polyisbutylene rubber, ethylenepropylene rubber, ethylene-propylene-diene rubbers, isobutylene-isoprene copolymers, polyurethane rubbers, polyamides, polyesters, polycarbonates, polyimides, polyethers, polyolefins, fluorpolymer laminates, Barex resin and Barex Laminates with Aclar.

Using the above described procedure, adhesive free sealing products are available in single-layer, multi-layer or roll form, which are provide sealing to the surface of multi-well plat surface through the adhesive which is already coated on the plate surface. The adhesive free sealing products can be selected for properties of solvent and chemical resistance, including resistance to DMSO, by application of fluoropolymeric materials. In addition, moisture barrier seals, oxygen barrier seals, resealable dimple free mats, gas permeable seals, clear and transparent seals, high or low temperature seals, low protein binding seal, temper evidence seals, and other applications can be acheived.

### EAMPLE 1

96-, 384-, and 1536 multi-well plates with U. F, V bottoms, which are made from polystyrene, polypropylene, or Masterblock 2 ml, polpropylene (commercially available from Greiner and Abgene companies) were treated as described. Water- and solvent-based acrylic plus UV-curable pressure sensitive adhesives were used for laying down continuous, connected adhesives on the treated well-plates surfaces. This procedure produced adhesive free areas around each well, which connected to outer periphery of the plate with continuous adhesive format. In addition, the above adhesives were dyed with blue, red, and other colors to provide more contrast to pattern adhesive arrays that were coated on the surface of the plates. Both water- and solvent-based pressure sensitive adhesives in virgin and dyed state provided cured adhesives with high tack value between 450-700 gram/cm². The UV-cured adhesive did not deliver the tack required for this application, plus property of the adhesive was severely damaged over time. All the multi-well plates prepared this way adhered to all desirable adhesive free films and dimple free-mat materials including 2 mil and 5 mil treated fluoropolymers, polypropylene, polyester, Barex films, 20 mil treated EPDM, silicone rubber, silicone rubber with Teflon laminates, aluminum foil, aluminum foil laminates with polyolefin, and butyl rubber elastometric materials, regardless of materials chemistry and temperature cycles required for a particular application. In addition, there was no trace of adhesive left on the surface of the sealing materials after removal from multi-well plate surface.

### EXAMPLE 2

The same materials that were covered in example 1 were subjected to heat-activated adhesive in a defined pattern format. In this case, water- and solvent-based heat-activated adhesives in virgin and dyed formulations were used for coating of a pattern on the surface of multi-well plates. The multi-well plate having a heat-activated pattern adhesive was laminated to the all desirable adhesive free films and dimple-free mat materials including 2 mil and 5 mil treated fluoropolymers, polypropylene, polyester, Barex films, 20 mil treated EPDM, silicone rubber, silicone rubber with Teflon, aluminum foil, aluminum foil laminates with polyolefin, and butyl rubber electrometric materials with platinum press which is heated up 300-350° F. under pressure of 20-50 psi. Both water- and solvent-based heat activated adhesive laminated well to all the mentioned materials.

What is claimed is:

1. A method of making a sealing product, which comprises
a) selecting a multi-well plate, which satisfies the all intended laboratory and pharmaceutical applications;
b) treating said multi-well sealing surface; and
c) coating said sealing surface of multi-well plate with an adhesive in a pattern format.

2. The method of claim 1, wherein the multi-well plate has a 4-, 6-, 12-, 24-, 48-, 96-, 384-, or 1536-well design.

3. The method of claim 1, wherein the multi-well plate is made of polyolefins in a virgin state or mixed with other materials and is clear, white or black.

4. The method of claim 3, wherein the multi-well plate has full-, semi- or non-skirted side profiles.

5. The method of claim 3, wherein the wells of the multi-well plate have raised rims around each well, flat well rims, well to well connections through negative space (chimney profile), non-chimney profile, and/or wells with differing wall thickness.

6. The method of claim 1, wherein the multi-well plates with self-sealing properties are suitable for experimental assays, sorbet assays, high-throughput screening (HTS) assays, combinatorial chemistry, drug discovery, drug metabolism studies, liquid chromatography with tandem mass spectrometry (LC-MS-MS), cell culture, tissue culture, and/or PCR/DNA analysis.

7. The method of claim 1, wherein the pattern format is in the form of 6-, 12-, 24-, 48-, 96-, 384- or 1536-wells.

8. The method of claim 1, wherein the wells of the multi-well plate are in the form of circles, squares or rectangles.

9. The method of claim 1, wherein said multi-well plate is treated in step b) to make the multi-well plate susceptible to bonding with a water-based, solvent-based, heat-activated, or UV curable adhesive.

10. The method of claim 1, which further comprises modifying the surface of the multi-plate plate with chemical, corona, plasma, flame, or mechanical treatment.

11. The method of claim 1, which further comprises coating or mixing a wetting agent on or with the multi-well plate.

12. The method of claim 1, wherein the adhesive is selected from the group consisting of water-based, solvent-based, heat-activated, UV-curable, colored, and transparent adhesive materials.

13. The method of claim 1, wherein the multi-well self sealing product has a pattern adhesive design applied to the periphery of adhesive free wells and the outer periphery of the multi-well plate in the shape of connected-donut shape, disconnected donut shape, rectangular perimeter, triangular perimeter or connected to the outer border.

14. A multi-well self sealing product made according to the method of claim 1, which can be adhered to a adhesive-free sealing materials in single, multi, or roll form which are made from elastometric materials, metallic foils, fluoropolymeric or composite or multi-layered mixes thereof.

15. The multi-well self-sealing product of claim 14, wherein the adhesive-free sealing material is a fluorinated or non-fluorinated material selected from the group consisting of perfluoroalkoxy tetafluoroethylene copolymer resin (PFA), ethylenechlorotrifluoroethylene copolymer resin (E-CTFE), ethyleneterafluoroethylene copolymer resin (E-TFE), polychlorotrifluoroethylene (CTFE), polyvinylidine fluoride (PVDF), tetrafluoroethylene-hexafluoropropylene (FEP), polytetafluoroethylene (PTFE), expanded PTFE, porous PTFE, woven glass impregnated with PTFE, skived or skived plus calendared PTFE, ACLAR homopolmer, ACLAR copolmer, dyneon TFM, polyimides (KAPTON), polyolefins, acrylic polymers or copolymers, vinyl halide polymers or copolymers, ethylene-methyl methacrylate copolymers, acrylonitrilestyrene copolymers, ABS resins, ethylene-vinyl acetate copolymers, natural and synthetic rubbers, butadienestyrene copolymers, polyisoprene, synthetic polyisprene, polybutadiene, butadiene-acrylonitrile copolymers, polychloroprene rubbers, polyisbutylene rubber, ethylenepropylene rubber, ethylene-propylene-diene rubbers, isobutylene-isoprene copolymers, polyurethane rubbers, polyamides, polyesters, polycarbonates, polyimides, polyethers, polyolefins, fluorpolymer laminates, Barex resin and Barex laminates with Aclar.

16. The multi-well self-sealing product of claim 14 wherein the adhesive-free sealing material is resistant to degradation by solvents and chemicals.

17. The multi-well self-sealing product of claim 16, wherein the adhesive-free sealing material is resistant to degradation from DMSO.

18. The adhesive-free sealing product of claim 14, wherein the adhesive-free sealing product forms a seal that is a moisture barrier seal, an oxygen barrier seal, a resealable dimple free mat, a gas permeable seal, a clear and transparent seal, a high or low temperature seal, a low protein binding seal, and/or a tamper evidence seal.
